(19) United States
(12) Patent Application Publication
(10) Pub. No.: US 2015/0165357 A1
(43) Pub. Date: Jun. 18, 2015

(54) Filter Structure

(71) Applicant: Ming-Chih Pan, Xinbei City (TW)

(72) Inventor: Ming-Chih Pan, Xinbei City (TW)

(21) Appl. No.: 14/108,349

(22) Filed: Dec. 17, 2013

(51) Int. Cl. B01D 35/30; B01D 29/50

(52) U.S. Cl. CPC B01D 35/306; B01D 29/50

(57) ABSTRACT

The present invention is to provide an improved filter structure comprising: a tank body, inside of said tank body provided with an isolating plate defining a first and a second room respectively, and provided with an inlet portion and on one end of said tank body, provided with a upper cover; a plurality of fastening unit, located separately on the isolating plate, each including the first annular bearing, a plurality of sealing rib, and an extending portion; a plurality of strut rod, with one end movably connected with the screw bracket of each extended portion; a plurality of compressive engaging unit, movably provided at another end of each strut rod; and a plurality of filter cartridge, provided with penetrating strut rod. Thereby, the present invention reaches the effect of simple in structure, easy to assembly, easy to dismount, easy to clean as well as stability in supporting filter cartridge.

### DESIGNATED REPRESENTATIVE DRAWING

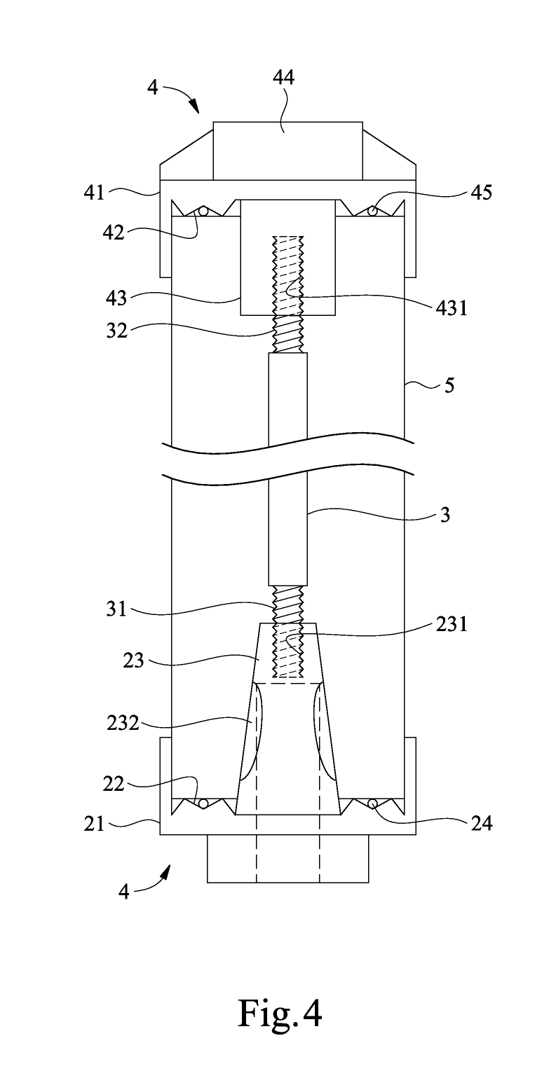

(1) The representative drawing of the present invention is FIG. 4.
(2) The legend of main components and symbols:
2 fastening unit
21 first annular bearing
22 sealing rib
23 extending portion
231 screw bracket
232 through hole
24 washer
3 strut rod
31, 32 screw shank
4 compressive engaging unit
41 second annular bearing
42 sealing rib
43 engaging portion
431 screw bracket
44 force applying portion
45 washer
5 filter cartridge

### DESCRIPTION OF THE INVENTION

1. Field of the Invention

The present invention is related to an improved filter structure especially to that with effect of simple in structure, easy to assembly, easy to dismount, easy to clean as well as stability in supporting filter cartridge.

2. Description of the Prior Art

In the light of the conventional filter device, owing to the necessity of avoiding distortion and damage to the filter cartridge, and enhancing the filtering effect of entire filter device, the ends and perimeter wall of the ends are all packaged and fixed, although makes the ends become sealed, but, in practical use, at least the following shortage will be happened.
1. The complexity of structure as a whole, and changing washer becomes necessary after a period of usage, and leads to inconvenience in assembling, dismounting, and cleaning.
2. The comprised components of the first fastening member and second fastening member are complex, leads to bad closing contact degree between the first and second fastening member and filter cartridge.
3. The opening method of the filter is through rotating up and removing sideway, that is not only wasting the work time and process but also occupied more space in the device.
4. The first fastening member has to be fastened with a pressing board or spring, that makes filter cartridge shaking and unstable.

Therefore, above mentioned conventional “filter cartridge fastening device” can not meet the needs of practical use.

### SUMMARY OF THE INVENTION

In view of the short comings of the filter structure of the prior art, moved with its imperfect, with years of accumulated experiences in the industry, endeavored in the research of overcoming those problems, the inventor developed an improved filter structure, that reaches the effect of simple in structure, easy to assembly, easy to dismount, easy to clean as well as stability in supporting filter cartridge.

For reaching above mentioned purposes, the improved filter structure comprises: a tank body, inside of said tank body provided with an isolating plate defining a first and a second room respectively, and provided with an inlet portion and an outlet portion of first and second room respectively, and on one end of said tank body, provided with a movable upper cover; a plurality of fastening unit, located separately on the isolating plate, each including the first annular bearing, a plurality of sealing rib, and an extending portion, connecting the first and second room; a plurality of strut rod, with one end movably connected with the screw bracket of each extended portion; a plurality of compressive engaging unit, movably provided at another end of each strut rod, each comprising a second annular bearing, a plurality of sealing rib, and an engaging portion butt connecting to the other end of the strut rod, and a force applying portion; and a plurality of filter cartridge, provided with penetrating strut rod with both end surface being butt contacted to the sealing rib of the first and second annular bearing.

### DETAILED DESCRIPTION OF THE PREFERRED EMBODIMENTS

For better understanding of the purpose, characteristics and effect of the present invention, through the following preferred embodiments, together with attached drawings, a detailed description is presented as following.

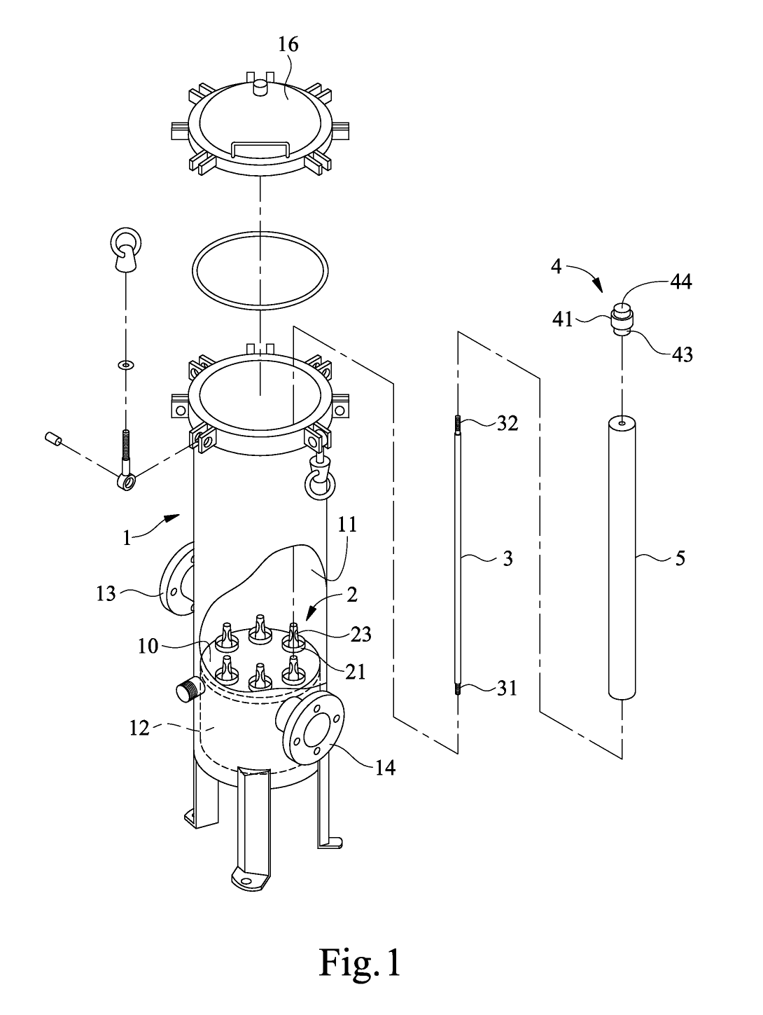

With reference to FIGS. 1, 2, 3, 4, the drawings shows, an exploded perspective schematic diagram, a partial cross-sectional schematic diagram, a side view status schematic diagram, and a schematic diagram showing the engagement of fastening unit, strut rod, force applying unit and filter cartridge, of the present invention. As shown in the drawings, the improved filter structure is at least comprised of a tank body 1, a plurality of fastening unit 2, a plurality of strut rod 3, a plurality of compressive engaging unit 4, and a plurality of filter cartridge 5.

Inside of the above said tank body 1, an isolating plate 10 is provided defining first and second room 11 and 12 respectively, and outside of said tank body 1, an inlet portion 13 and an outlet portion 14 are provided connecting first and second room 11 and 12 respectively, and on the side fringe of one end of said tank body 1, a movable upper cover 16 is provided.

Each one of the fastening unit 2 is located on the isolating plate 10, including the first annular bearing 21 being welded to the isolating plate 10, a plurality of sealing rib 22 being provided on the bottom inside the first annular bearing 21, and a plurality of extending portion 23 being provided on the first annular bearing 21, connecting the first and second room 11, 12, wherein, each sealing rib 22 being in a gradually shrinking shape, engaging with each sealing rib 22, a washer 24 being provided inside the first annular bearing 21, a screw bracket 231 being provided around the end of each extending portion 23, and a through hole 232 being provided on both sides of each extending portion 23, connecting the first and second room 11, 12 serving as passing through of the filtrate from the first room 11 to the second room 12.

On both end of each strut rod 3, a screw shank 31, 32 is provided respectively, and movably connected with screw bracket 231 of the extended portion 23.

Each compressive engaging unit 4 is movably provided at one end of each strut rod 3, comprising a second annular bearing 41, a plurality of sealing rib 42 being provided on the bottom in the second annular bearing 41, and engaging portion 43 being provided on a side of the second annular bearing 41 and connecting to the other end of the strut rod 3, and a force applying portion 44 being located on the other side of the second annular bearing 41, wherein, each sealing rib 42 being in a gradually shrinking shape, engaging with each sealing rib 42, a washer 45 being provided inside the second annular bearing 41, and on an end of each engaging portion 43, provided with a screw bracket 431, which butt connect with the screw shank 32 of the other end of strut rod 3.

Each filter cartridge 5 is provided with penetrating strut rod 3 with both end surface being butt contacted to the sealing rib 22, 42 of the first and second annular bearing 21, 41.

The filtering method of a filter, being known to those skilled in the art, will not be further described here, only the effect of the present invention will be further described as in the following.

While mounting the filter, with the upper cover 16 opened, with each filter cartridge 5 being penetrated by a strut rod 3, rotating the force applying portion 44 of the second annular bearing 41 with a tool by external force, whereby, butt connecting the screw bracket 431 of the engaging portion 43 of the second annular bearing 41 with the screw shank 32 on an end of the strut rod 3, so that the sealing rib 22, 42 of the first and second annular bearing 21, 41 butt contacting each end surface of the filter cartridge 5, with the washer 24, 45 on sealing rib 22, 45 the closing contact degree between the first and second annular bearing 21, 41 and both end surface of the filter cartridge being strengthened, and since the first annular bearing 21 being stationary fixed on the isolating plate 10 and the end surfaces of the first and second annular bearing 21, 41 being butt contacted to the end surfaces of the filter cartridge 5, thus, after the second annular bearing 41 being engaged with the strut rod 3, the filter cartridge 5 becomes stably attached on strut rod 3 and seams being avoided, thereby, filtering effect being enhanced.

While dismounting the filter, rotating the force applying portion 44 of the second annular bearing 41 with a tool by external force, whereby, disengaging the screw bracket 431 of the engaging portion 43 of the second annular bearing 41 with the screw shank 32 on an end of the strut rod 3, thereby, the filter cartridge 5 being dismounted, then rotating an end of each strut rod 3 with external force, thereby, disengaging the screw shank 31 of each strut rod 3 from the screw bracket 231 of the extending portion 23, thus, the first room of tank body 1 becomes cleared and the effect of easy to dismount and easy to clean tank body 1 is reached.

In addition, because both ends of each strut rod are butt connected with the screw shank 31, 32 matching the screw bracket 231, 431 of each extending portion 23 and engaging portion 43, thereby the fine adjustment of the distance between the first and second annular bearing 21, 41 can be made through the strut rod 3.

As mentioned above the present invention completely matches with the requirements of novelty, non-obviousness, and industry applicability for granting a patent. About novelty and non-obviousness, the improved filter structure of the present invention reaches the effect of simple in structure, easy to assembly, easy to dismount, easy to clean as well as stability in supporting filter cartridge; about industry applicability, the derived product from the present invention will be sufficiently meet the needs of the present market.

The present invention has been disclosed with the preferred embodiments, however, for those skilled in the art, it should be understood that the preferred embodiments described is only used to explain the present invention instead of limiting the range of the present invention. It is to be noted that the compatible variation and range of the preferred embodiments should be subject to the attached claims.

### BRIEF DESCRIPTION OF THE DRAWINGS

FIG. 1 is an exploded perspective schematic diagram of the present invention;

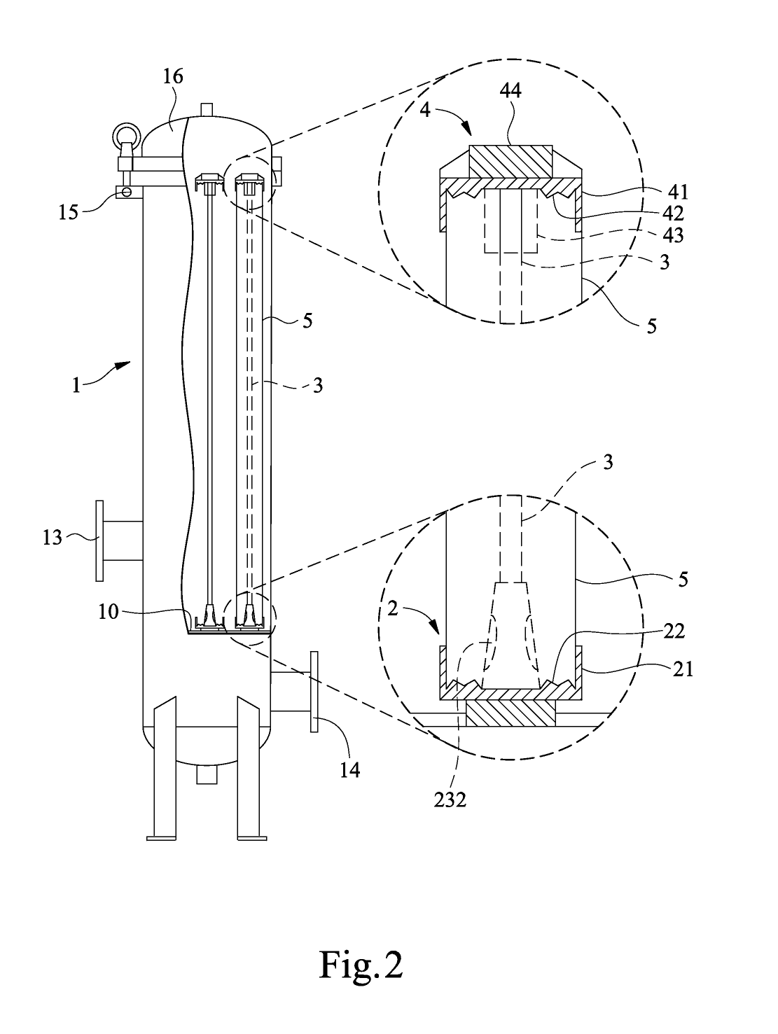

FIG. 2 is a partial cross-sectional schematic diagram of the present invention;

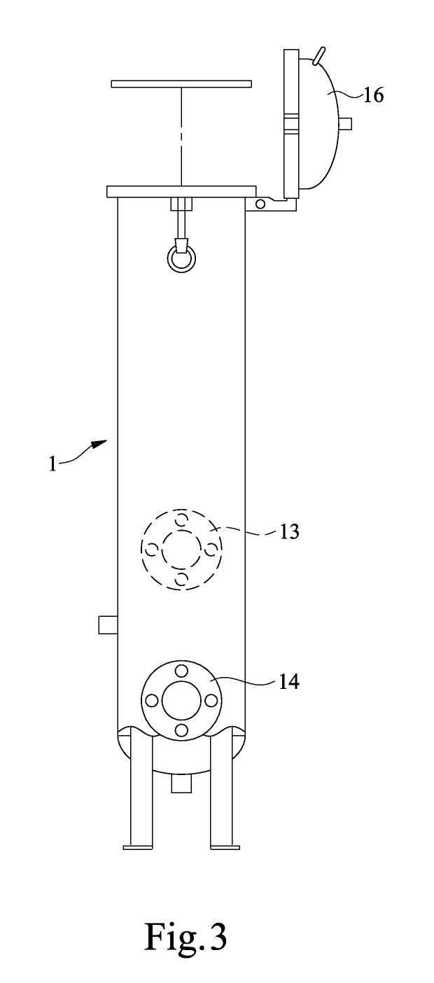

FIG. 3 is a side view status schematic diagram of the present invention;

FIG. 4 is a schematic diagram showing the engagement of fastening unit, strut rod, force applying unit and filter cartridge of the present invention.

### LEGEND OF MAIN COMPONENTS AND SYMBOLS

1 tank body
10 isolating plate
11 first room
12 second room
13 inlet portion
14 outlet portion
16 upper cover
2 fastening unit
21 first annular bearing
22 sealing rib
23 extending portion
231 screw bracket
232 through hole
24 washer
3 strut rod
31, 32 screw shank
4 compressive engaging unit
41 second annular bearing
42 sealing rib
43 engaging portion
431 screw bracket
44 force applying portion
45 washer
5 filter cartridge

What is claimed is:

1. An improved filter structure comprising:
a tank body, inside of said tank body provided with an isolating plate defining a first and a second room respectively, and outside of said tank body, provided with an inlet portion and an outlet portion connecting first and second room respectively, and on the side fringe of one end of said tank body, provided with a movable upper cover;
a plurality of fastening unit, located separately on the isolating plate, each including the first annular bearing, a plurality of sealing rib being provided on the bottom inside the first annular bearing, and an extending portion being provided on the first annular bearing, connecting the first and second room;
a plurality of strut rod, with one end movably connected with the screw bracket of each extended portion;
a plurality of compressive engaging unit, movably provided at another end of each strut rod, each comprising a second annular bearing, a plurality of sealing rib being provided on the bottom in the second annular bearing, and an engaging portion, being provided on a side of the second annular bearing and connecting to the other end of the strut rod, and a force applying portion being located on the other side of the second annular bearing; and
a plurality of filter cartridge, provided with penetrating strut rod with both end surface being butt contacted to the sealing rib of the first and second annular bearing.

2. An improved filter structure as recited in claim 1 wherein each of said sealing rib of each said first annular bearing being in a gradually shrinking shape, and a washer being provided inside said first annular bearing.

3. An improved filter structure as recited in claim 1 wherein a through hole being provided on both sides of each said extending portion, connecting the first and second room.

4. An improved filter structure as recited in claim 1 wherein on both end of each said strut rod, a screw shank is provided respectively, and movably connected with said screw bracket of said extended portion.

5. An improved filter structure as recited in claim 1 wherein each of said sealing rib of each said second annular bearing being in a gradually shrinking shape, and a washer being provided inside said first annular bearing.
